(19) United States
(12) Patent Application Publication
(10) Pub. No.: US 2008/0110941 A1
(43) Pub. Date: May 15, 2008

(54) Rotational Dispensing Cap Closure for a Liquid Container

(75) Inventors: Donald D. Foster, St. Charles, MO (US); Philip L. Nelson, Wildwood, MO (US)

Correspondence Address: THOMPSON COBURN, LLP, ONE US BANK PLAZA, SUITE 3500, ST LOUIS, MO, 63101, US

(73) Assignee: CONTINENTALAFA DISPENSING COMPANY, St. Peters, MO (US)

(21) Appl. No.: 11/559,707

(22) Filed: Nov. 14, 2006

(51) Int. Cl. B67D 3/00

(52) U.S. Cl. 222/507

(57) ABSTRACT

A cap closure that dispenses liquid from a liquid container has a cylindrical base that is removably mounted on the liquid container. A valve spout is mounted on the base for linear reciprocating movement. A valve actuator is mounted on the base for rotation. The spout is movable between closed and opened positions where in the opened position liquid can be dispensed through the spout and in the closed position the liquid is blocked from passing through the spout. The actuator is operatively connected to the spout whereby rotation of the actuator between first and second positions relative to the cap base moves the spout between the respective closed and opened positions of the spout on the base.

### BACKGROUND OF THE INVENTION

(1) Field of the Invention

The present invention pertains to a cap closure having a cylindrical base that is removably mounted on a liquid container. A spout is mounted on the base for linear reciprocating movement. A valve actuator is mounted on the base for rotation. The spout is movable between closed and opened positions, where in the opened position liquid can be dispensed through the spout and in the closed position the liquid is blocked from passing through the spout. The actuator is operatively connected to the spout whereby rotation of the actuator between first and second positions relative to the closure base moves the spout between the respective closed and opened positions of the spout on the base.

(2) Description of the Related Art

A variety of different types of liquid container caps have been designed that include a liquid dispenser spout incorporated in the cap. A basic cap design includes a spout that is an integral part of the cap, and a closure or cover that is removably attached to the end of the spout. The cover is removed to dispense the liquid from the container through the spout, and is then re-attached over the end of the spout to seal the liquid inside the container.

Another common example of a liquid dispenser cap includes a spout that is mounted on the container cap for pivoting movement between opened and closed positions of the spout. A surface of the cap is formed with a recessed slot that receives the spout when the spout is pivoted to the closed position. The spout is manually pivoted out of the slot to the opened position. In the opened position, the liquid contents of the container can be dispensed through the spout. When the spout is moved back to the closed position, the pivoting movement of the spout into the slot closes a flow path of the liquid through the spout and seals the liquid in the container.

These prior art liquid dispensing caps have been found to be disadvantaged in that, in the first example, the closure or cover can be separated from the cap. If the closure is lost and cannot be attached over the end of the spout, the liquid contents of the container cannot be sealed from the exterior environment of the container, which could lead to the contamination of the container contents.

In the second example of the prior art dispensing cap the entire spout is positioned in the cap slot in the closed position of the spout. It is often difficult to manually pivot the dispensing spout from the closed position in the slot.

What is needed to overcome these disadvantages associated with prior art liquid dispensing caps is a liquid dispensing cap having a permanently attached spout that is easily manually moved between closed and opened positions. In the closed position the liquid flow path through the spout is sealed, and in the opened position the spout extends from the cap to direct liquid dispensed from the attached container.

### SUMMARY OF INVENTION

The liquid dispensing cap of the present invention overcomes the disadvantages associated with prior art liquid dispensing caps. The cap has four basic component parts, a base that is removably attachable to a liquid container, a liquid dispensing spout on the base, a valve element in the spout, and an actuator on the base. Each of the component parts is constructed of a plastic material conventionally used in constructing such caps.

The base of the cap is primarily designed to be removably attached to a liquid container, the contents of which are to be dispensed by the dispensing cap. In alternative embodiments, the cap could be an integral part of the liquid container. The cap has an integral liquid discharge passage with an inlet opening at one end, and an outlet opening at an opposite end. The inlet opening communicates with the contents of the liquid container. A sealing surface in the form of a stopper plug is provided inside the liquid discharge passage.

The spout is mounted in the liquid discharge passage for linear reciprocating movement between a first, closed position and a second, opened position of the spout housing relative to the cap base. The spout has an interior bore that extends completely through the spout. A valve element is positioned in the bore. The valve element includes a resiliently flexible portion that engages in sealing engagement against the interior surface of the spout bore. When subjected to liquid pressure, the flexibility of the valve element allows the valve element to move away from the interior surface of the spout bore, and allows liquid to be dispensed through the spout bore past the valve element and from the spout. When the spout is moved to the first, closed position of the spout relative to the base, the sealing surface of the base liquid discharge passage closes the interior bore of the spout. This closes the liquid flow path through the liquid dispensing cap. When the spout is moved to the second, opened position of the spout relative to the base, the sealing surface of the base liquid discharge passage is displaced from the spout bore, communicating the spout bore with the interior of the liquid container.

The actuator is mounted on the cap base for rotation of the actuator between first and second positions of the actuator relative to the base. The actuator is also operatively connected to the spout to cause the spout to move in response to rotation of the actuator on the base. When the actuator is rotated to its first position relative to the base, the operative connection of the actuator to the spout moves the spout to its first, closed position relative to the base. When the actuator is rotated to its second position relative to the base, the operative connection of the actuator to the spout causes the spout to move to its second, opened position relative to the base.

Thus, the liquid dispensing cap of the invention is easily manually operated to cause the spout to move between its closed and opened positions. In the closed position, the spout seals the interior of the liquid container connected to the dispensing cap. In the opened position, the spout projects from the dispensing cap, allowing the liquid to be dispensed from the liquid container through the dispensing cap while directing the dispensed liquid from the end of the spout.

### DESCRIPTION OF DRAWINGS

Further features of the invention are set forth in the following detailed description of the preferred embodiment of the invention and in the drawing figures.

FIG. 1 is a front perspective view of the liquid dispensing cap in the closed condition of the cap.

FIG. 2 is a side sectioned view of the cap in the closed condition.

FIG. 3 is a front perspective view of the liquid dispensing cap in the opened condition of the cap.

FIG. 4 is a side sectioned view of the liquid dispensing cap in the opened condition.

### DETAILED DESCRIPTION OF THE PREFERRED EMBODIMENT

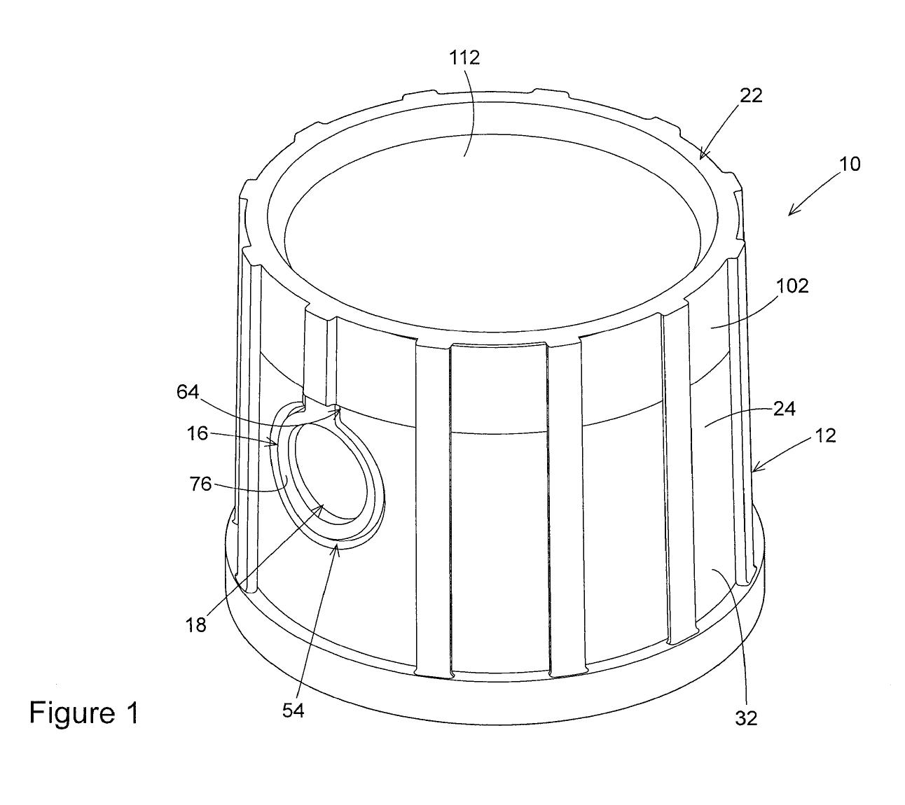

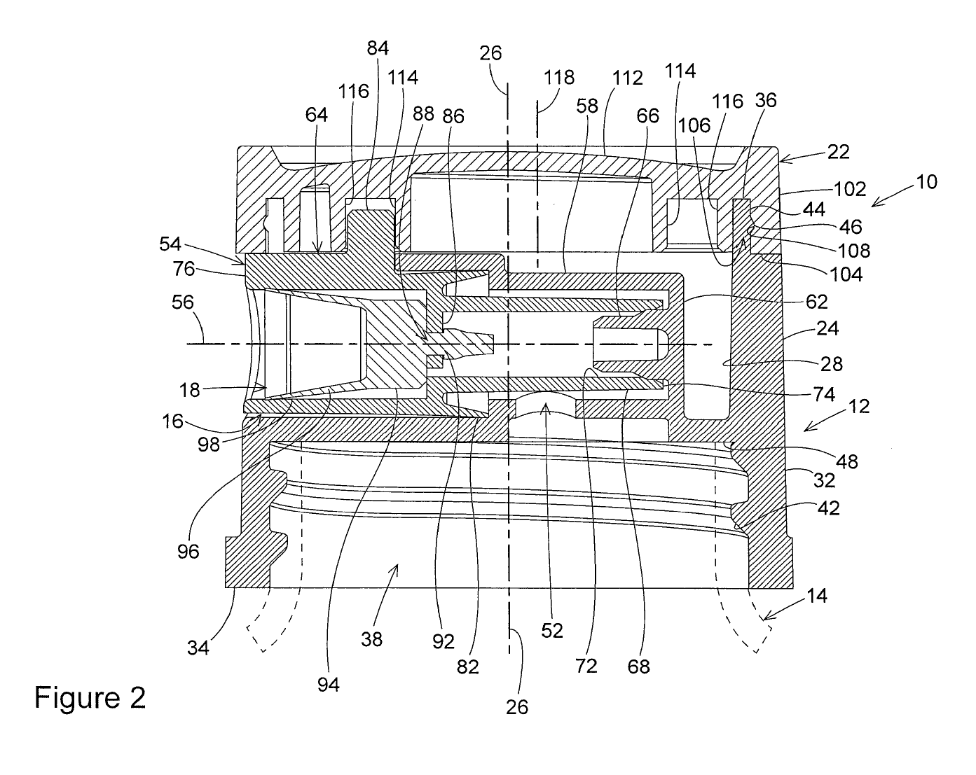

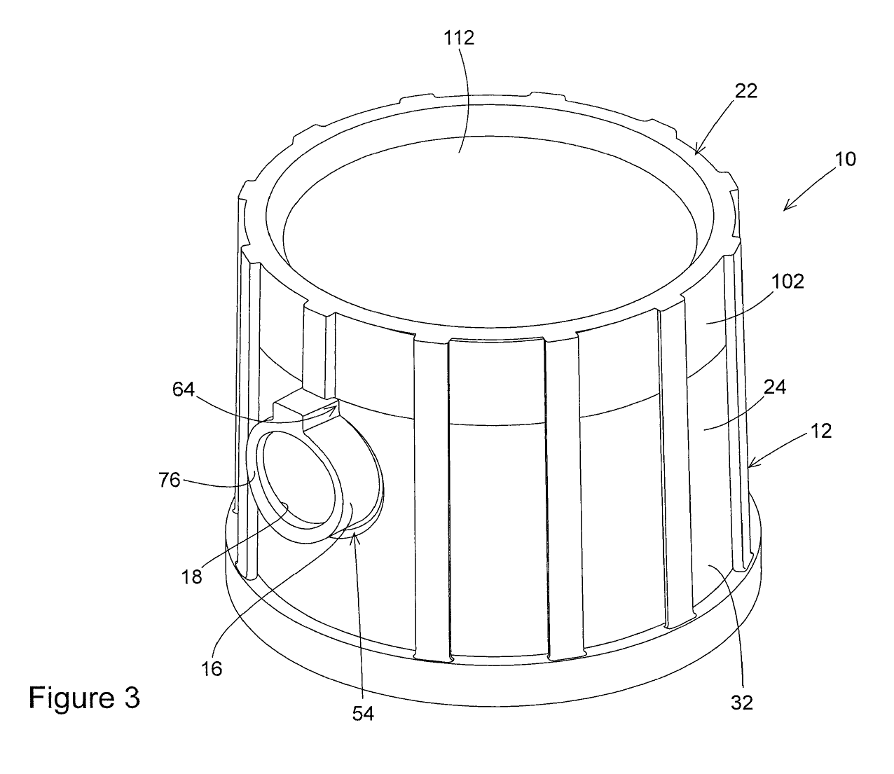

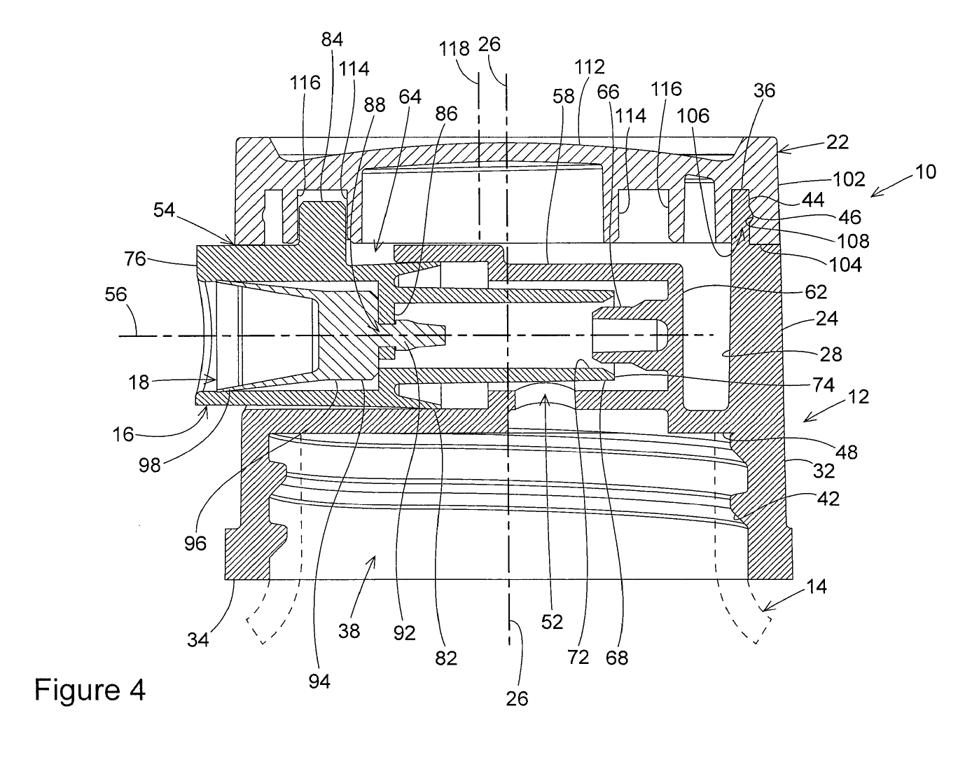

The liquid dispensing cap of the present invention is shown in FIGS. 1-4 in a closed condition of the cap and an opened condition of the cap. FIGS. 1 and 2 show the cap in the closed condition. FIGS. 3 and 4 show the cap in the opened condition. As stated earlier, the cap 10 has four basic component parts, a base 12 that is removably attachable to a liquid container 14 represented in dashed lines in FIGS. 2 and 4, a liquid dispensing spout 16 on the base 12, a valve element 18 in the spout 16, and an actuator 22 on the base 12. Each of these component parts is constructed of a plastic material conventionally used in constructing such caps. The material of the valve element is more resilient and flexible than the material of the other component parts. In the drawing figures, the dispensing cap 10 is represented as being removably attachable to the liquid container 14. This is the preferred embodiment. In alternate embodiments, the liquid dispensing cap 10 could be an integral part of the liquid container.

The cap base 12 has a cylindrical configuration defined by a cylindrical side wall 24 of the base. The side wall 24 has a center axis 26 that defines mutually perpendicular axial and radial directions relative to the base 12 and relative to the dispensing cap 10. The base side wall has opposite interior 28 and exterior 32 surfaces, and axially opposite first 34 and second 36 circular end surfaces. The first circular end surface 34 of the base defines the opening into the interior volume 38 of the base that is attachable to the separate liquid container 14. Adjacent the first end surface 34 of the side wall 24, the side wall has an interior surface configuration in the form of internal screw threading 42 for attaching the base to the container. Other types of attachable fitments, for example, a bayonet-type fitment, may also be used.

The base side wall 24 has a reduced diameter portion 44 adjacent the base second end surface 36. The reduced diameter portion 44 extends around a majority of the base side wall 24. An annular rib 46 projects radially outwardly from an exterior surface of the reduced diameter portion 44. The rim 46 is used in attaching the actuator 22 to the base 12 for rotation of the actuator relative to the base, as will be explained.

A circular intermediate wall 48 extends from the side wall interior surface 28 and divides the base interior volume 38 into two portions. A liquid inlet opening 52 passes through the intermediate wall 48. The inlet opening 52 communicates with the interior of a liquid container attached to the base 12.

A circular side wall opening 54 passes through the side wall 24 intermediate the side wall first end surface 34 and second end surface 36. The side wall opening 54 communicates an exterior environment of the cap 10 to the interior volume of the base 12. The side wall opening 54 has a radial center axis 56.

A cylindrical tubular wall 58 is formed integrally with the base intermediate wall 48. The tubular wall 58 has an interior bore that defines a liquid discharge passage and is coaxial with the side wall opening center axis 56. The interior bore of the tubular wall 58 communicates with the exterior environment of the cap 10 through the side wall opening 54. The tubular wall 58 extends radially inwardly from the side wall interior surface 28 and the side wall opening 54 to an end wall 62. The base inlet opening 52 passes through the tubular wall 58 adjacent the end wall 62. A slot opening 64 is provided through the tubular wall 58 on an opposite side of the liquid discharge passage from the inlet opening 52. The slot 62 has a straight radial length and intersects the side wall opening 54.

A cylindrical stopper plug 56 projects axially into the interior bore of the liquid discharge passage from the passage end wall 62. The stopper plug 66 has a cylindrical exterior surface that functions as a sealing surface in the liquid discharge passage, as will be explained.

The spout 16 is mounted in the liquid discharge passage defined by the base tubular wall 58 for linear reciprocating movement along the tubular wall center axis 56. The spout 16 has a cylindrical exterior surface 68 and a cylindrical interior surface 72. The cylindrical interior surface 72 extends radially through the spout between a first end 74 of the spout adjacent the liquid discharge passage end wall 62, to a second end 76 of the spout positioned adjacent the side wall opening 54. The interior surface 72 surrounds a spout interior bore that is coaxial with the tubular wall center axis 56. The diameter dimension of the spout is reduced adjacent the spout first end 74, whereby the spout interior surface 72 adjacent the spout first end 74 can engage in a sealing engagement over the exterior surface of the stopper plug 66. The exterior diameter dimension of the spout adjacent the spout second end 76 is enlarged, whereby the spout engages in a sliding engagement in the side wall opening 54.

A sliding seal 82 having a truncated cone shape projects radially outwardly from an intermediate portion of the spout exterior surface 68. The seal 82 engages in a sliding sealing engagement with the interior surface of the base tubular wall 58. The spout seal 82 seals the liquid discharge passage in the base tubular wall 58 from the exterior environment of the dispensing cap.

A cam follower post 84 projects outwardly from the spout exterior surface 68 adjacent the spout second end 76. The post 84 extends through the base tubular wall slot 64. The slot 64 holds the post 84 and the spout 16 against rotation around the spout center axis 56, but allows linear reciprocating movement of the post 84 through the slot 64 and thereby allows linear reciprocating movement of the spout 16 in the base tubular wall 58.

A plurality of spokes 86 extend radially into the center of the spout interior bore from the spout interior surface 72. Only one of the spokes 86 is shown in FIGS. 2 and 4. In the preferred embodiment, three spokes extend from the spout interior surface 72 to the center axis 56 of the spout. The spokes have a center opening 88 that is coaxial with the spout center axis 56. The spacing between adjacent spokes 86 defines a portion of a liquid flow path through the spout interior bore defined by the spout interior surface 72.

The valve element 18 is positioned inside the spout 16 adjacent the spout second end 76. The valve element 18 has a stem 92 that is inserted into the spoke opening 88 to secure the valve element 18 to the spout 16. The valve element stem 92 holds a plurality of flanges 94 of the valve element against the spout spokes 86. In the embodiment shown in the drawing figures, there are four flanges 94 spatially arranged around the stem 92. The engagement of the flanges 94 against the spout spokes 86 holds the valve element 18 centered in the interior bore of the spout 16. The spacing between adjacent flanges 94 defines a portion of the liquid flow path through the spout interior bore.

A cup-shaped seal 96 of the valve element extends from the flanges 94 toward the spout second end 76. The seal 96 has a truncated cone configuration that extends radially outwardly as it extends from the valve element flanges 94 toward the spout second end 76. A circular end 98 of the seal engages in sealing engagement with the spout interior surface 72 adjacent the spout second end 76. As the cup-shaped seal 96 extends to the circular sealing surface 98, the thickness reduces and the resiliency of the seal increases. Thus, the cup-shaped seal 96 engages in sealing engagement with the spout interior surface 72 in an at rest condition of the seal shown in FIGS. 2 and 4. When the seal 96 is subjected to fluid pressure from liquid flowing through the spout interior bore and engaging against the exterior surface of the seal 96, the seal flexes inwardly allowing the liquid to pass the sealing surface 98 and be dispensed from the spout second end 76.

The actuator 22 has a cylindrical wall 102 that is mounted on the side wall reduced diameter portion 44 for rotation of the actuator 22 relative to the base 12. The base center axis 26 is coaxial with a rotation axis of the actuator 22. The actuator wall 102 has a circular end surface 104 with a circular slot 106 recessed into the end surface. The circular slot 106 is dimensioned to receive the base side wall reduced diameter portion 44 in mounting the actuator 22 to the base 12 for rotation of the actuator relative to the base. This connection allows the actuator 22 to rotate in more that one complete rotation in either direction on the base 12. An annular groove 108 is formed in one side of the actuator wall slot 106 and is positioned to receive the rim 46 on the base side wall reduced diameter portion 44. The engagement of the rim 46 in the groove 108 secures the actuator 22 to the base 12.

A circular wall 112 extends across the actuator cylindrical wall 102 at an opposite end of the wall from the circular end surface 104. The circular wall closes over the opening of the base 12 surrounded by the second circular end surface 36 of the base.

An inner cam wall 114 having an inner cam surface and an outer cam wall 116 having an outer cam surface project axially from the actuator circular wall 112 toward the base 12. The opposing cam surfaces of the inner cam wall 114 and the outer cam wall 116 define a cam groove between the cam surfaces. In the embodiment of the dispensing cap 10 shown in the drawing figures, the inner cam wall 114 and the outer cam wall 116 are concentric circular walls having a center axis 118. The center axis 118 is also the center axis of the cam slot defined between the two walls 114, 116. As seen in FIGS. 2 and 4, the cam center axis 118 is off-set or eccentric relative to the center axis 56 of the base 12 and the actuator 22. Although the cam slot defined between the two walls 114, 116 is circular in the embodiment shown in the drawing figures, other configurations of the cam slot may be employed. The cam slot walls 112, 114 are positioned to engage in sliding engagement with opposite sides of the spout cam post 84. Thus, on rotation of the actuator 22 on the base 12, the cam slot walls 112, 114 move in sliding engagement across opposite sides of the spout post 84.

In operation of the dispensing cap, in the relative positions of the component parts shown in FIGS. 1 and 2, the spout 16 is in a first, closed position relative to the base 12. The actuator 22 is also shown in a first position of the actuator relative to the base 12. In this position the spout first end 74 engages in sealing engagement against the sealing surface 66 of the base tubular wall 58. The sealing surface is provided on the stopper plug 66 that engages against the spout interior surface 72 at the spout first end 74. This closes a liquid flow path from a liquid container 14 connected to the dispensing cap 10, through the base inlet opening 52 into the liquid passage defined by the base tubular wall 58, and through the interior bore of the spout 16 defined by the spout interior surface 72.

On rotation of the actuator 22 from its first position relative to the base 12 toward its second position relative to the base shown in FIGS. 3 and 4, the actuator cam walls 112, 114 engage in sliding engagement across opposite sides of the spout post 84. Due to the eccentricity of the cam slot defined by the cam walls 112, 114, the rotation of the actuator 22 on the base 12 causes the spout 16 to move linearly from the first position of the spout 16 in the liquid discharge passage toward a second position of the spout 16 in the liquid discharge passage. FIGS. 3 and 4 show the second position of the spout 16 in the liquid discharge passage. The spout 16 is moved to this second position by rotating the actuator 180° from its first position shown in FIGS. 1 and 2, to the second position of the actuator 22 relative to the base 12 shown in FIGS. 3 and 4. In this position of the spout 16, the spout first end 74 has been removed from its sealing engagement with the sealing surface of the stopper plug 66. This opens the liquid flow path from the liquid container 14 connected to the dispensing cap 10, through the base inlet opening 52 and through the liquid discharge passage defined by the tubular wall 58 into the spout interior bore defined by the spout interior surface 72. Liquid flowing along the liquid flow path passes between the spout spokes 86 and between the valve element flanges 94 and exerts a pressure on the exterior surface of the valve cup-shaped seal 96. The liquid pressure causes the circular sealing surface 98 of the valve cup-shaped seal 96 to disengage from its engagement with the spout interior surface 72, causing the liquid to be dispensed from the spout second end 76. As shown in FIGS. 3 and 4, with the spout 16 moved to its second, open position relative to the base 12, the spout is extended from the side wall opening 54. This extension of the spout 16 assists in directing the liquid dispensed from the spout second end 76.

Thus, the liquid dispensing cap of the present invention provides a closure cap with a dispensing spout that is easily manually moved between a closed and sealed position relative to the cap and an opened position relative to the cap. In addition, as the spout is moved to its opened position a distal end of the spout projects from the cap to assist in dispensing liquid from the spout.

Although the liquid dispensing cap of the invention has been described above by reference to a specific embodiment, it should be understood that modifications and variations could be made to the cap without departing from the intended scope of the claims.

1. A liquid dispensing cap comprising:
a base that is attachable to a liquid container, the base having a liquid inlet opening that communicates with the liquid container when the base is attached to the liquid container;
a dispensing spout mounted on the base for liner reciprocating movement between first and second positions of the spout relative to the base, the spout having an interior bore that communicates with the base inlet opening and opens a liquid flow path from a liquid container attached to the base, through the base inlet opening and through the spout interior bore to an exterior environment of the cap when the spout is in the second position relative to the base, and the spout interior bore being blocked from communication with the base inlet opening and thereby closing the liquid flow path when the spout is in the first position relative to the base; and,
an actuator mounted on the base for rotational movement between first and second positions of the actuator relative to the base, the actuator being operatively connected to the spout for moving the spout linearly between the first and second positions of the spout relative to the base in response to the actuator being rotated between the respective first and second positions of the actuator relative to the base.

2. The cap of claim 1, further comprising:
the base having a tubular liquid discharge passage with a cylindrical wall; and,
the spout being mounted in sliding engagement inside the liquid discharge passage wall.

3. The cap of claim 2, further comprising:
the base inlet opening being in the liquid discharge passage wall.

4. The cap of claim 2, further comprising:
the base having a sealing surface inside the liquid discharge passage wall; and,
the spout engages with the sealing surface in the first position of the spout relative to the base, the base sealing surface thereby closing the liquid flow path.

5. The cap of claim 4, further comprising:
the base having a projecting plug that projects into the liquid discharge passage and the base sealing surface being on the plug, the plug being positioned in the liquid discharge passage to engage inside the spout bore in the first position of the spout relative to the base, the base sealing surface on the plug thereby closing the liquid flow path.

6. The cap of claim 1, further comprising:
a resilient, flexible valve inside the spout interior bore.

7. The cap of claim 1, further comprising:
a cam surface on the actuator; and,
a cam follower on the spout, the cam follower engaging with the actuator cam surface and thereby operatively connecting the actuator to the spout whereby rotational movement of the actuator relative to the base causes sliding movement of the cam surface against the cam follower which causes liner movement of the spout relative to the base.

8. The cap of claim 1, further comprising:
a cam groove on the actuator; and,
a cam follower post on the spout, the post projecting from the spout and engaging in the actuator cam groove thereby operatively connecting the actuator to the spout whereby rotational movement of the actuator relative to the base causes sliding movement of cam follower post through the cam groove which causes liner movement of the spout relative to the base.

9. The cap of claim 8, further comprising:
the cam groove forms a continuous loop on the actuator.

10. The cap of claim 1, further comprising:
the actuator is rotatable on the base in at least one complete rotation.

11. The cap of claim 1, further comprising:
the base having a cylindrical sidewall with a center axis that defines mutually perpendicular axial and radial directions; and,
the spout being mounted on the base for radially directed reciprocating movement.

12. The cap of claim 1, further comprising:
the actuator being mounted on the base for rotational movement around an axis of rotation, the axis of rotation defining mutually perpendicular axis and radial directions; and,
the spout being mounted on the base for radially directed reciprocating movement.

13. A liquid dispensing cap comprising:
a base having a liquid inlet opening;
an actuator mounted on the base for rotation of the actuator around a rotation axis, the rotation axis defining mutually perpendicular axial and radial directions relative to the actuator, the actuator being rotatable between first and second positions of the actuator relative to the base; and,
a dispensing spout mounted on the base for radially directed reciprocating movement, the spout being radially movable on the base between first and second positions of the spout relative to the base, the spout having a radially directed interior bore that communicates with the base inlet opening and opens a liquid flow path through the base inlet opening and through the spout interior bore to an exterior environment of the cap when the spout is in the second position relative to the base, and the spout interior bore being blocked from communication with the base inlet opening and closing the liquid flow path through the base inlet opening and the spout interior bore when the spout is in the first position relative to the base, the spout being operatively connected to the actuator for moving the spout between the first and second positions of the spout relative to the base in response to the actuator being rotated between the respective first and second positions of the actuator relative to the base.

14. The cap of claim 13, further comprising:
a cam surface on the actuator; and,
a cam follower on the spout, the cam follower engaging with the actuator cam surface and thereby operatively connecting the actuator to the spout whereby rotational movement of the actuator relative to the base causes sliding movement of the cam surface against the cam follower which causes liner movement of the spout relative to the base.

15. The cap of claim 13, further comprising:
a cam groove on the actuator; and,
a cam follower post on the spout, the post projecting from the spout and engaging in the actuator cam groove thereby operatively connecting the actuator to the spout whereby rotational movement of the actuator relative to the base causes sliding movement of cam follower post through the cam groove which causes liner movement of the spout relative to the base.

16. The cap of claim 13, further comprising:
the base having a tubular liquid discharge passage with a cylindrical wall; and,
the spout being mounted in sliding engagement inside the liquid discharge passage wall.

17. The cap of claim 16, further comprising:
the base having a sealing surface inside the liquid discharge passage wall; and,
the spout engages with the sealing surface in the first position of the spout relative to the base, the base sealing surface thereby closing the liquid flow path.

18. A liquid dispensing cap comprising:
a base having a cylindrical sidewall with a center axis that defines mutually perpendicular axial and radial directions relative to the cap, the sidewall having axially opposite first and second circular ends and having opposite exterior and interior surfaces, the sidewall interior surface surrounding an interior volume of the base and having an interior surface configuration adjacent the first end of the sidewall for attaching the base to a liquid container, the sidewall having an opening through the sidewall positioned axially between the first and second sidewall ends, the base having a liquid discharge passage with a tubular wall that extends radially from the sidewall interior surface into the base interior volume, the liquid discharge passage communicating with the sidewall opening at one end of the liquid discharge passage and communicating with an inlet opening through the liquid discharge passage wall at an opposite end of the liquid discharge passage, the inlet opening communicating the liquid discharge passage with a liquid container when the base is attached to the liquid container;
a spout mounted in a sliding sealing engagement in the liquid discharge passage tubular wall for radial reciprocating movement between first and second positions of the spout in the liquid discharge passage, the spout having radially opposite first and second ends and a hollow interior bore extending radially through the spout between the spout first and second ends, the spout first end engaging with a portion of the discharge passage wall closing communication between the liquid discharge passage and the spout bore when the spout is in the first position in the liquid discharge passage, and the spout first end being disengaged from the portion of the liquid discharge passage wall opening communication between the liquid discharge passage and the spout bore when the spout is in the second position in the liquid discharge passage, the spout having a cam follower that projects from the spout outside of the liquid discharge passage; and,
an actuator mounted on the base sidewall second end for rotation of the actuator about the base center axis between first and second positions of the actuator relative to the base, the actuator having a cam surface that engages against the spout cam follower and causes the spout to move to the first and second positions of the spout in the liquid discharge passage in response to the actuator being rotated to the respective first and second positions of the actuator relative to the base.

19. The cap of claim 18, further comprising:
the actuator having a pair of opposing cam surfaces and the spout cam follower projects from the spout between the pair of cam surfaces.

20. The cap of claim 18, further comprising:
the actuator has a groove and the cam surface is in the groove; and, the spout cam follower projects from the spout into the groove.

21. The cap claim 20, further comprising:
the actuator groove being circular and having a groove center axis that is parallel to and spaced from the base center axis.

22. The cap of claim 18, further comprising:
a flexible, resilient tubular valve in the spout bore.
